(19) United States
(12) Patent Application Publication
(10) Pub. No.: US 2019/0251647 A1
(43) Pub. Date: Aug. 15, 2019

(54) SYSTEM AND METHOD FOR REAL ESTATE E-FLYER DISTRIBUTION

(71) Applicant: ZYF Marketing LLC, Lynnwood, WA (US)

(72) Inventors: Caitlin Sarah Thornburg, Snohomish, WA (US); Kristen Thornburg, Edmonds, WA (US); Neil Paul Johnston, Lynnwood, WA (US)

(21) Appl. No.: 16/268,219

(22) Filed: Feb. 5, 2019

Related U.S. Application Data
(60) Provisional application No. 62/629,544, filed on Feb. 12, 2018.

(51) Int. Cl. G06Q 50/16; G06F 16/27; H04L 29/08

(52) U.S. Cl. CPC G06Q 50/163; H04L 67/10; G06F 16/27

(57) ABSTRACT

A system and method for providing real-time database driven e-flyers to real estate agents. An e-flyer distribution server generates an e-flyer based on listing details provided by a real estate agent. The e-flyer distribution server utilizes a real-estate-agent database to distribute the e-flyer to real estate agents that are identified based on their target region. Real estate agents utilize an e-flyer presentation module on a mobile computing device to receive and view the e-flyers that are provided to that real estate agent. The real estate agent can interact with the e-flyer to perform additional actions associated with the e-flyer.

### TECHNICAL FIELD

The present disclosure pertains to real estate content distribution and, more particularly, to dissemination of real-time database driven electronic flyers to multiple mobile electronic devices.

### BACKGROUND

### Description of the Related Art

Today, home buying can be a tedious process, from finding particular property listings to the intricacies of signing a purchase agreement. Typically, home buyers hire real estate agents to help with these tasks. Similarly, many home sellers hire real estate agents to promote, advertise, and help sell their property. Accordingly, seller real estate agents market their for-sale listings not only to consumers, but to buyer real estate agents hoping that a buyer real estate agent will see the listing and bring their client, the buyer, to see the property and potentially make an offer to purchase.

In the past, seller real estate agents generally held an open house to show the property to prospective buyers or to buyer real estate agents. Along with the open house, seller real estate agents often create a paper flyer to hand deliver to prospective buyers and buyer real estate agents, such as at an open house or through the U.S. Postal Service.

But in the past few years, seller real estate agents have been moving away from or supplementing paper flyers with email flyers. Seller real estate agents would generally prepare the email flyers themselves or have a marketing company prepare them. Once created, the seller real estate agent could distribute the email flyer to other real estate agents via email. Other times, the marketing company could distribute the email flyers via email to real estate agents who subscribe to receive such email flyers. In this way, real estate agents can receive emails with email flyers of the most recent property listings.

Unfortunately, there are many issues with the distribution of paper flyers and email flyers. For example, if a selling price of a property is reduced, the paper flyers and the previously sent email flyers are all out of date. Moreover, real estate agents have less control over how and when they receive email flyers. For example, some email providers, e.g., enterprise or corporate email providers, are making decisions that impact which emails get delivered into inboxes, which reduces a recipient's ability to control which emails they can receiving in their inboxes.

The timing of email delivery can further impact the success of an email flyer. For example, if one email provider delays releasing an email for some time, e.g., due to a virus scan, then the recipient of that email flyer may be delayed compared to other recipients. Some recipients might want to review email flyers at a particular time each day to be confident that they did not miss anything. Email flyers, as they are delivered now, generally do not allow for this kind of control because email flyers can be delivered into their inbox throughout the day. Oftentimes, email flyers are also intermingled with all of their other business and personal emails, which can make it difficult to sort through each email and focus on email flyers. Moreover, many recipients do not have control over how their emails are listed or presented in their inbox, due to ever-changing algorithms of their email provider, which can lead to the recipient having to sift through many emails to locate each separate email flyer and to open each one individually.

It is with respect to these and other considerations that implementations of the present disclosure are provided.

### BRIEF SUMMARY

Implementations of the present disclosure are generally directed towards a system for the dissemination of real-time database driven electronic flyers to multiple mobile electronic devices. The system comprises a real-estate-agent database and an e-flyer distribution server. The real-estate-agent database includes a plurality of real-estate-agent profiles that each indicate a target region for a respective real estate agent. The e-flyer distribution server comprises a memory that stores computer instructions and a processor that performs actions when executing the computer instructions. The e-flyer distribution server receives listing details of a property from a seller real estate agent and generates an e-flyer based on the listing details, wherein the e-flyer includes a property element and at least one interactive element. The e-flyer distribution server can present the e-flyer to the seller real estate agent for acceptance prior to dissemination to mobile computing devices of real estate agents. In response to receiving a request from a target real estate agent, the e-flyer distribution server accesses the real-estate-agent database to select the e-flyer for distribution to the target real estate agent based on the target region of the e-flyer and the target region of the real estate agent.

The mobile computing device of a real estate agent comprises a memory that stores computer instructions and a processor that performs actions when executing the computer instructions. The mobile computing device provides the request from the target real estate agent to the e-flyer distribution server and receives the e-flyer in response. The mobile computing device presents the property element of the e-flyer and the at least one interactive element of the e-flyer to the target real estate agent. The property element may include a photo, a text, an icon, or a graphic, or some combination thereof, depicting information regarding the property that is being presented in the e-flyer. And the at least one interactive element may include at least one of a link to a website associated with the property, a link to a website associated with the seller real estate agent, information regarding the seller real estate agent, or mapping details regarding the property, or some combination thereof.

The mobile computing device can perform additional actions associated with the e-flyer in response to receiving an input to one of the at least one interactive element. These additional actions may include posting a copy of the e-flyer to a social media page; sending a copy of the e-flyer to another computing device via text message or email; activating a telephone application of the mobile computing device to dial a phone number associated with the e-flyer; or activating a map application of the mobile computing device to focus on a location of the property associated with the e-flyer; or some combination thereof.

### BRIEF DESCRIPTION OF THE SEVERAL VIEWS OF THE DRAWINGS

The foregoing and other features and advantages of the present disclosure will be more readily appreciated as the same become better understood from the following detailed description when taken in conjunction with the accompanying drawings, wherein:

FIG. 1 is a context diagram that illustrates an example implementation of an environment that provides real-time database-driven real estate electronic flyers as described herein;

FIG. 2 is a logical flow diagram that illustrates one implementation of a process by an e-flyer distribution server for generating an electronic flyer as described herein;

FIG. 3 is a logical flow diagram that illustrates one implementation of a process by an e-flyer distribution server for selecting and providing electronic flyers to a mobile computing device as described herein;

FIG. 4 is a logical flow diagram that illustrates one implementation of a process by a mobile computing device for presenting an electronic flyer to a real estate agent as described herein;

FIGS. 5A-5D are screenshots of a mobile computing device that is displaying real-time database-driven real-estate electronic flyers; and

FIG. 6 is a system diagram of computing systems for implementation of the process and method of the present disclosure.

### DETAILED DESCRIPTION

In the following description, certain specific details are set forth in order to provide a thorough understanding of various disclosed implementations. However, one skilled in the relevant art will recognize that the present disclosed implementations may be practiced without one or more of these specific details or with other methods, components, materials, etc. In other instances, well-known structures or components or both that are associated with the environment of the present disclosure have not been shown or described in order to avoid unnecessarily obscuring descriptions of the implementations.

Throughout the specification, claims, and drawings, the following terms take the meaning explicitly associated herein, unless the context clearly dictates otherwise. The term “herein” refers to the specification, claims, and drawings associated with the current application.

Unless the context requires otherwise, throughout the specification and claims that follow, the word “comprise” and variations thereof, such as “comprises” and “comprising” are to be construed in an open inclusive sense, that is, as “including, but not limited to.” The foregoing applies equally to the words “including” and “having.”

The phrases “in one implementation,” “in another implementation,” “in various implementations,” “in some implementations,” “in other implementations,” and other variations thereof refer to one or more features, structures, functions, limitations, or characteristics of the present disclosure, and are not limited to the same or different implementations unless the context clearly dictates otherwise.

As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the disclosure, the meaning of “a,” “an,” and “the” include singular and plural references.

The following are various definitions of terms utilized herein to provide a general description of the terms, but are not intended to be an exclusive or exhaustive description.

As used herein, the term “seller real estate agent” refers to real estate agents that are representing or helping property sellers. Conversely, the term “buyer real estate agent” refers to real estate agents that are representing or helping prospective property buyers. Use of the term “real estate agent” without a designation of “seller” or “buyer” generally refers real estate agents, regardless of whether they are representing property sellers, property buyers, or neither.

As used herein, the terms “electronic flyer” and “e-flyer” may be used interchangeably and refer to visual and interactive content regarding real estate (also referred to as “property” herein) that is for sale. E-flyers are provided from an e-flyer distribution server to a mobile computing device for display on the mobile computing device.

E-flyers include two main types of elements: a property element and one or more interactive elements. The property element includes photos, text, icons, graphics, and other information regarding the property that is being presented in the e-flyer. The interactive elements are displayable, interactive objects that are presented with the property element, which allow a viewing real estate agent to interact with the e-flyer. For example, the interactive elements may include one or more links to a website associated with the property, one or more links to a website associated with the seller real estate agent, information regarding the seller real estate agent, mapping details regarding the property (e.g., a link to a map application that focuses in on the property), or other interactive elements. In some implementations, if the e-flyer is being provided to the seller real estate agent associated with the e-flyer, then the e-flyer may also include one or more additional interactive elements that enable the seller real estate agent to modify or edit the e-flyer.

Although e-flyers are described herein as referred to the sale of real estate or real property, implementations are not so limited. In other implementations, e-flyers can include information regarding automobiles for sale; boats for sale; other items, products, or personal property for sale, or other types of information that is to be distributed to subscribing users. Thus, the seller real estate agent may also be generically referred to as a seller and the buyer real estate agent may also be generically referred to a buyer.

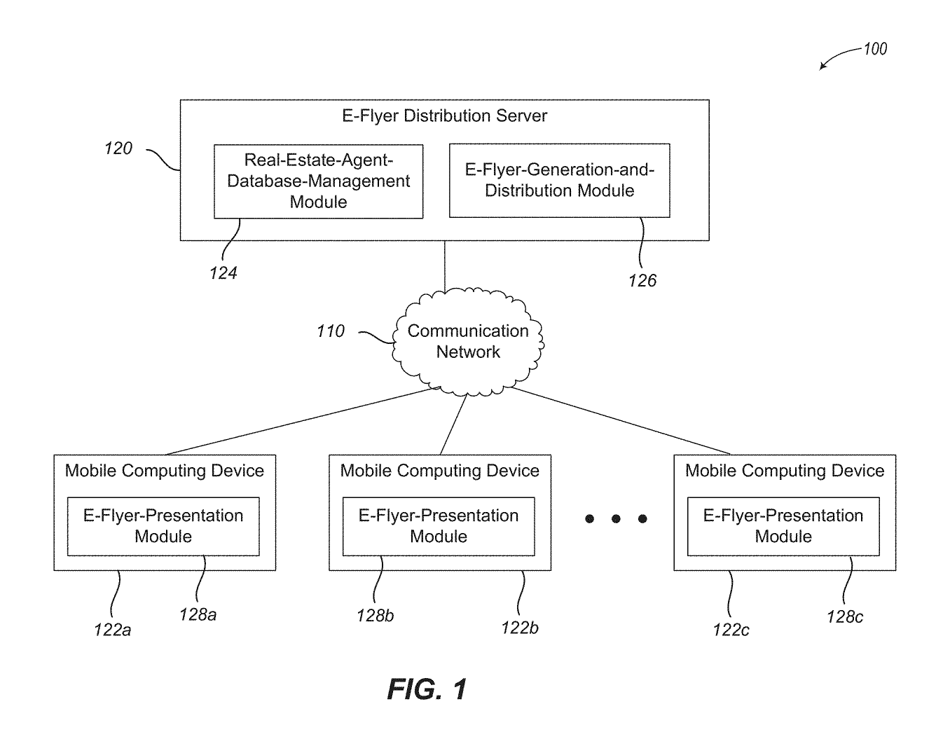

FIG. 1 is a context diagram that illustrates an example implementation of an environment 100 that provides real-time database-driven real-estate electronic flyers described herein. The environment 100 includes an e-flyer distribution server 120 and a plurality of mobile computing devices 122a-122c. The mobile computing devices 122a-122c are structured to communicate with the e-flyer distribution server 120 via a communication network 110, which may be any combination of wired or wireless networks.

The e-flyer distribution server 120 includes a real-estate-agent-database-management module 124 and an e-flyer-generation-and-distribution module 126. The real-estate-agent-database-management module 124 is capable of generating and managing real-estate-agent profiles in a real-estate-agent database. Each profile includes various types of information about a corresponding real estate agent and a target region for e-flyers that they are interested in receiving. The e-flyer-generation-and-distribution module 126 is capable of generating e-flyers for real estate agents and distributing them according to real-estate-agent profiles stored in a real-estate-agent database. The use of module herein refers to computer instructions or computer programs that, when executed by a processor, cause the processor to perform actions described herein, unless the context clearly dictates otherwise.

Each mobile computing device 122a-122c includes an e-flyer-presentation module 128a-128c, respectively, that is capable of communicating with the e-flyer distribution server and presenting e-flyers to the corresponding real estate agents. Briefly, the e-flyer-presentation module 128, along with the e-flyer distribution server 120, are capable of generating lists of new e-flyers from multiple seller real estate agents for properties in a target region of the real estate agent accessing the e-flyer-presentation module 128. Real estate agents can view and access these e-flyers at times convenient for them or can receive e-flyers at particular times. Thus, e-flyer-presentation module 128 and the e-flyer distribution server 120 improve the daily problem facing real estate agents of communicating with each other and sharing marketing information for their listings.

In many instances, seller real estate agents that represent a property, market that property to buyer real estate agents. E-flyers, as described herein, provide seller real estate agents a great deal of creativity to market and present a property in a light most favorable to the seller. For example, e-Flyers are generally very different from the way listings are displayed in local and regional Multiple Listing Services (MLS's). The MLS is a database where agents input their listings, and other agents can search by certain categories to find potential listings that may work for their buyers. An MLS listing may include photos, a paragraph of text about the property, and formatted columns of detailed information about the history of the property. MLS listings typically have requirements about what details can be included and the arrangement of any photos. For example, the MLS may require that the main photo of the property in the database needs to be the exterior of the home.

An MLS search for a particular type of property generates a Hot Sheet that includes a list of properties that match the search parameters, which is presented in a text based table. Thus, MLS listings are less about marketing a property and more about a lookup database. Once a listing is identifies in an MLS search, a real estate agent can individually access each listing to view its details.

E-flyers, on the other hand, provide seller real estate agents the opportunity to present a property listing in an attractive way, and the way the seller real estate agent wants to show it. For example, if the property has a great view or a renovated chef's kitchen, then the e-flyer can promote these aspects; rather than focusing on other less-attractive features.

Just as seller real estate agents want to market their listings, buyer real estate agents want to see the marketing that is most relevant to them and their buyers. Buyer real estate agents typically prefer to see marketing information about listings in a particular target region (e.g., a particular geographical area, specific property attributes, etc.) to find a potential property that may suit their buyer.

The e-flyer-presentation module 128, described herein, provides an interactive interface that enables a seller real estate agents to market their listings and for buyer real estate agents to view those listings that are important to them. The e-flyer-presentation module 128 includes a graphical user interface where a real estate agent can log in and view e-flyers in their particular target region all at once, or the real estate agent can specifically search for e-flyers inside or outside their target region based on additional search criteria. The user interface of the e-flyer-presentation module 128 allows real estate agents to view each listing e-flyer one right after the other for their target region.

Additionally, the e-flyer-presentation module 128 enables the real estate agent to interact with various different interactive objects to contact the seller real estate agent, view the seller real estate agent's website, see a virtual tour of the property, view a map of the geographical location of the property, share the e-flyer across their own social media platforms and text the e-flyer to other real estate agents or their potential buyers.

The mobile computing devices 122a-122c include various different types of computing devices that can be utilized by a real estate agent to interact with the e-flyer distribution server 120. Some examples of mobile computing devices 122a-122c include, but are not limited to, smartphones, tablets, laptop computers, or other mobile electronic devices. Other non-mobile computing devices may also be employed as a mobile computing device 122, such as a desktop computer.

Implementations presented herein provide systems and methods for distributing e-flyers in the real estate industry to solve the daily problem facing real estate agents of communicating marketing information with each other. Implementations described herein enable seller real estate agents to efficiently market a property, while allowing buyer real estate agents to efficiently view such marketing.

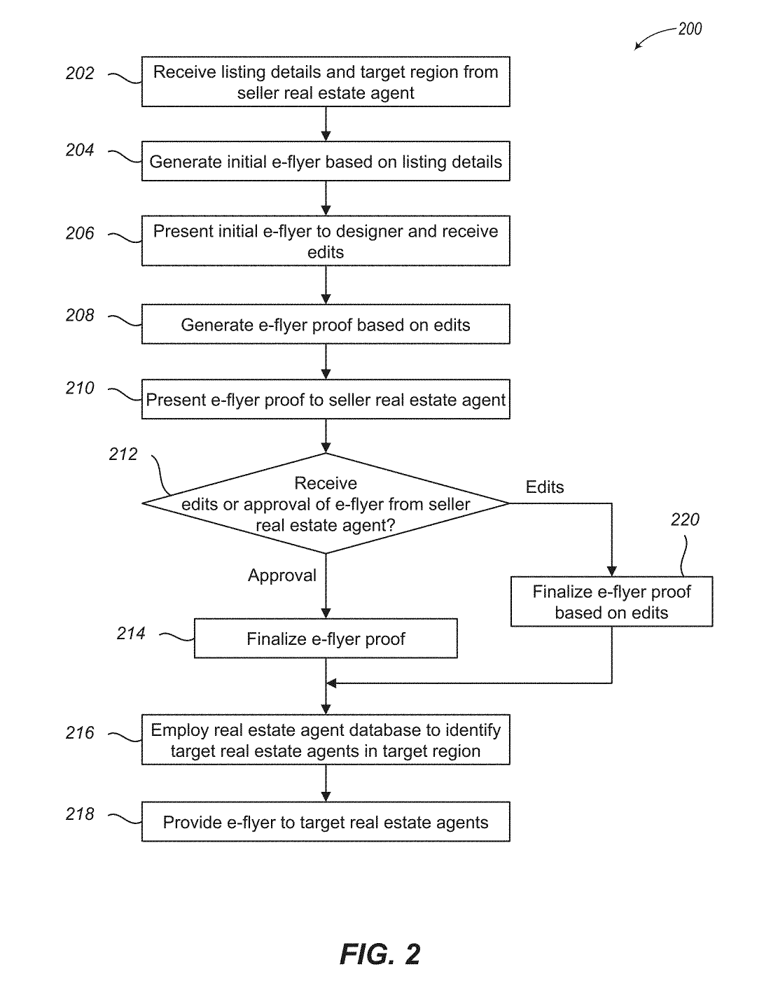

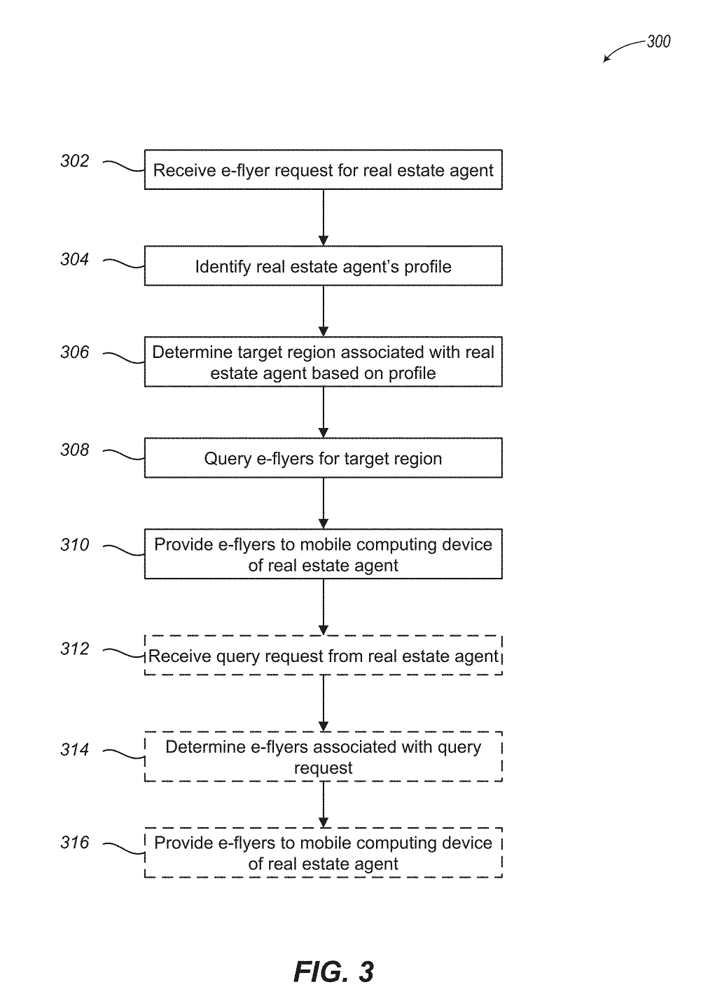

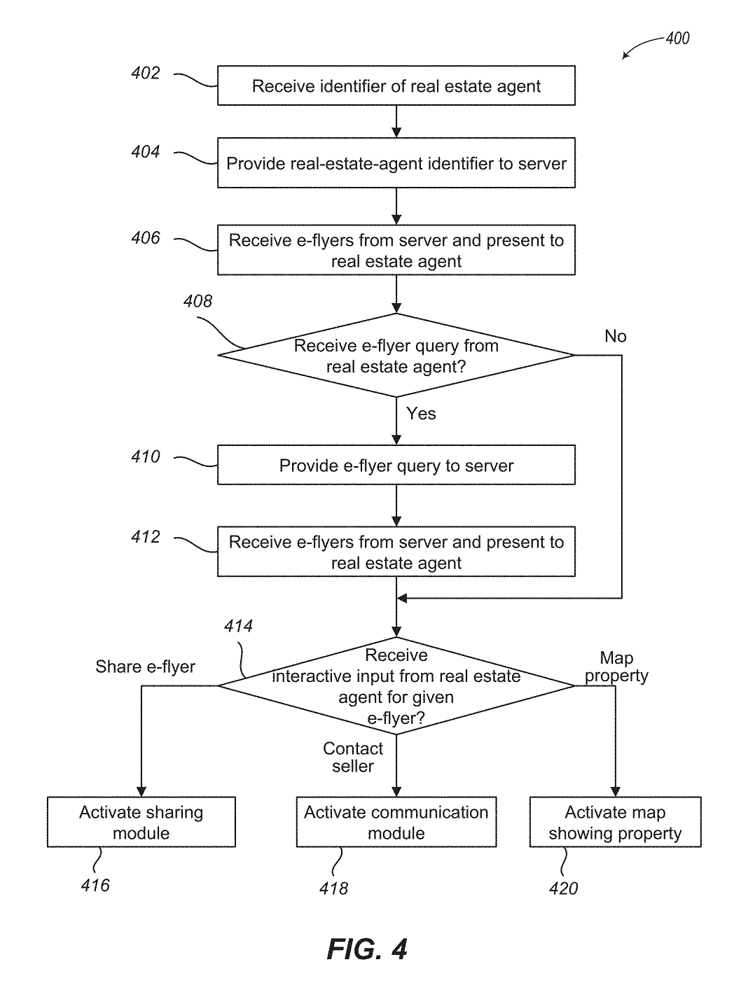

The operation of certain aspects will now be described with respect to FIGS. 2-4. In at least one of various implementations, processes 200 and 300 described in conjunction with FIGS. 2 and 3, respectively, may be implemented by or executed on one or more computing devices, such an e-flyer distribution server 120, and the process 400 described in conjunction with FIG. 4, may be implemented by or executed on one or more other computing devices, such as a mobile computing device 122.

FIG. 2 is a logical flow diagram that illustrates one implementation of a process by an e-flyer distribution server for generating an electronic flyer as described herein. FIG. 2 illustrates one implementation of the process when a real estate agent places an E-Flyer order through the distribution of the E-Flyer to a plurality of real estate agents.

The process 200 begins at block 202, where listing details and a target region for an e-flyer are received from a seller real estate agent. The listing details include information about the property, as well as information about the seller real estate agent. The listing details may include, for example, sale price, photos of the property, number of bedrooms, number of bathrooms, square footage, lot size, the seller real estate agent's name, a company in which the seller real estate agent is employed or associate, the seller real estate agent's contact information (e.g., website address, phone number, office location, etc.), or other types of information to describe the property listing. The listing details may be provided in the form of text, images, graphics, or other content. The listing details are utilized to generate the property element and interactive elements of the e-flyer.

In some implementations, the seller real estate agent can utilize a web-based interface to separately upload photos and one or more property details, which are utilized by the e-flyer distribution server 120 to generate the property element of the e-flyer. In at least one such implementation, the e-flyer distribution server 120 can present a plurality of e-flyer templates to the seller real estate agent from which the seller real estate can choose. The seller real estate agent can also separately input information regarding the seller real estate agent, such as telephone number, website address, or other contact information.

In other implementations, the seller real estate agent can generate his/her own property element for the e-flyer and upload it to the e-flyer distribution server 120, such as via a web-based interface or other API. For example, the seller real estate agent can generate a pdf, jpeg, or other file with images, text, and other listing details that can be used as the property element for the e-flyer. Even if the seller real estate agent uploads their own, previously generated, property element, the seller real estate agent can also input specific listing details, such as the sales price, square footage, seller-real-estate-agent information, etc.

Along with the listing details the seller real estate agent identifies a target region by zip code, price point, membership exclusivity, type of property, size of property, or other factors. This target region is used to identify other real estate agents from a database in which to distribute the e-flyer.

The process 200 proceeds to block 204, where an initial version of the e-flyer is generated. As discussed above, the e-flyer includes two main elements, the property element and one or more interactive elements.

The property element may be an image (e.g., jpeg or other image format) or other display object generated from the listing details provided by the seller real estate agent. In some implementations, the property element of the initial e-flyer is the document uploaded by the seller real estate agent. In other implementations, the property element is automatically generated based on the listing details and seller-real-estate information provided by the seller real estate agent. For example, a template e-flyer may include various different tags and their respective locations on the e-flyer template, where each tag may identify one or more different types of data, information, text, images, or icons that can be positioned at a given location within the property element of the e-flyer template. When a seller real estate agent inputs various listing details, the seller real estate agent can identify particular tags associated with the listing details or the user interface may include text boxes or other interactive objects that correspond to particular tags.

The interactive elements may be interactive icons or other displayable objects that are associated with various interactive functions. For example, one interactive element may be an icon that includes a link to a website associated with the property. Another interactive element may be an icon that includes a link to a website associated with the seller real estate agent. Yet another interactive element may be an icon that includes a link to a mapping website or application that, when accessed, focuses on the property. In still another example, an interactive element may be an icon that accesses the mobile computing device's phone capabilities and automatically dials the seller real estate agent's telephone number. Another interactive element may be an icon that when activated forwards the e-flyer to another real estate agent or posts the property element of the e-flyer to a social media page of the real estate agent that viewed the e-flyer. In various implementations, the e-flyer distribution server does not create the displayable object associated with an interactive element, rather generates the information necessary for a receiving mobile computing device to generate the interactive element.

In some implementations, the details or information that are used to create the interactive elements may be obtained from the listing details directly input by the seller real estate agent. In other implementations, where the seller real estate agent uploaded a pdf, jpeg, or other document containing various listing details, various text recognition techniques may be utilized to identify the listing details and information of the property and the seller real estate agent information, which can then be utilized to generate the interactive elements.

The process 200 continues at block 206, where the initial e-flyer is presented to a designer and any changes or edits to the e-flyer are received. In various implementations, the e-flyer server presents human designers with an initial version of the e-flyer. The designers can then utilize a graphical user interface to arrange photos and text, adjust sizing and font styles, proofread, modify agent contact information, create or edit interactive elements (e.g., change or add hotlinks to the website presenting the property listing or hotlinks to the agent's website), or make other adjustments as needed.

The process 200 proceeds next to block 208, where a proof of the e-flyer is generated based on the edits from the designer. In various implementations, this generation is performed by incorporating the received edits and the initial e-flyer generated at block 204.

The process 200 continues next at block 210, where, the e-flyer proof is presented to the seller real estate agent for review and editing. In various implementations, a notification is sent to the seller real estate agent's mobile computing device 122 to notify the seller real estate agent that the proof is ready for review. In some implementations, the seller real estate agent can access the e-flyer proof on the e-flyer distribution server 120 via a web-based interface. In other implementations, the e-flyer distribution server 120 sends the e-flyer proof to the seller real estate agent's mobile computing device 122, where the seller real estate agent can access the e-flyer proof via an application executing on the agent's mobile computing device 122, such as e-flyer-presentation module 128. In some implementations, the application provides a link to the e-flyer proof on the e-flyer distribution server 120, and the e-flyer distribution server 120 provides an interface in which the seller real estate agent can change or approve the e-flyer. In other implementations, the application provides an interface in which the seller real estate agent can view, change, or approve the e-flyer.

The process 200 then proceeds to decision block 212, where edits or approval of the e-flyer proof are received from the seller real estate agent. In various implementations, the seller real estate agent can utilize a web-based interface or an application interface executing on the seller real estate agent's mobile computing device 122 to edit or approve the e-flyer proof.

In some implementations, the seller real estate agent's mobile computing device 122 transmits any edits or approval to the e-flyer distribution server 120. Such edits may include instructions or commands to identify which text, icons, pictures, or other information to change and how to change it. In various implementations, the seller real estate agent clicks an accept button or other graphical user interface object to input and send a command to the e-flyer distribution server 120 indicating that the e-flyer proof is accepted. If the proof is accepted, process 200 flows to block 214, where the e-flyer proof is finalized. In various implementations, finalization of the e-flyer proof includes updating the e-flyer to indicate that it is ready to be transmitted to target real estate agents.

If, at decision block 212, edits are received from the seller real estate agent, process 200 flows from decision block 212 to block 220 to finalize the e-flyer proof based on the received edits. In various implementations, the e-flyer proof is modified based on the edits provided by the seller real estate agent. In some implementations, the seller real estate agent may request to review the modified e-flyer proof, in which case process 200 may loop (not illustrated) to block 210 to present the modified e-flyer to the seller real estate agent and obtain additional edits or approval at decision block 212. Otherwise, the modified e-flyer proof is finalized to indicate that it is ready to be transmitted to the target real estate agents.

Once the e-flyer proof is approved by the seller real estate agent and finalized at block 214 or modified and finalized at block 220, the process 200 continues at block 216, where a real estate agent database is employed to identify other real estate agents in the target region identified by the seller real estate agent.

The real estate agents database maintains a list of a plurality of real estate agents and a profile for each separate real estate agent. Each respective profile includes various different types of information associated with the respective real estate agent. For example, each real estate agent in the database may be associated with one or a plurality of different zip codes or regions in which they operate or are licensed to operate, a price range that they are comfortable working in, the type or size of properties (e.g., lot size or house square footage) that their clients typically look for, specific property details (e.g., on a golf course, waterfront lot, etc.), specialized memberships that they may have, other seller real estate agents, or other types of information that can be used to classify or characterize the real estate agents so that they receive e-flyer that are relative to them and their clients. A real estate agent's profile can also include other types of delivery information. For example, the profile may identify one or more specific times of day in which send new or updated e-flyers to the real estate agent's mobile computing device 122. Likewise, the profile can specify that if an e-flyer that was previously sent to the real estate agent is modified or otherwise updated, then the updates are to be automatically provided to the real estate agent. In this way, a real estate agent can receive price reduction information in real time, without having to wait for the specified delivery time.

The process 200 proceeds next at block 218, where the e-flyer is provided to the target real estate agents, which is discussed in more detail below in conjunction with FIG. 3. Briefly, in some implementations, a push notification is sent to each target real estate agent's mobile computing device 122 to indicate that there are one or more new or updated e-flyers. In at least one implementation, the e-flyer is sent to a mobile computing device 122 for access and display via an application executing on the mobile computing device 122, such as e-flyer-presentation module 122, as discussed herein. In at least one such implementation, the e-flyer is presented to the target real estate agent as an image along with the interactive elements. In other implementations, the push notification includes a link to the e-flyer that is stored on a remote server. In some other implementations, an email is generated with at least some of the e-flyer elements and sent to each target real estate agent.

After block 218, the process 200 terminates, ends, or otherwise returns to a calling process to perform other actions.

FIG. 3 is a logical flow diagram that illustrates one implementation of a process by an e-flyer distribution server 120 for selecting and providing electronic flyers to a mobile computing device as described herein.

The process 300 begins at block 302, where the e-flyer distribution server 120 receives an e-flyer request from a real estate agent. In some implementations, this request is automatically generated based on profiles of the real estate agents in the database. For example, if a real estate agent requests e-flyers to be distributed at a particular time of day, then this request is triggered at that particular time of day for that particular real estate agent. In other implementations, the request is received from the mobile computing device 122 of the real estate agent, which is discussed more in conjunction with FIG. 4.

The process 300 proceeds to block 304, where a profile associated with the real estate agent is identified. In various implementations, an identifier, such as an email address, phone number, or other unique identifier of the real estate agent is received. The real-estate-agent database is then queried for the real estate agent's profile based on the received identifier.

The process 300 continues at block 306, where a target region associated with the real estate agent is determined based on the profile. As discussed above, the real-estate-agent profile may identify one or more zip codes or counties for the real estate agent. These zip codes identify geographical areas where the real estate agent has an interest in receiving e-flyers of property in the same geographical areas. Although discussed in terms of geographical areas, the target region may also be identified by other criteria. For example, the target region may indicate that the real estate agent is interested in seeing e-flyers for waterfront properties or properties on golf courses. As another example, the target region may be for a particular seller real estate agent or company. In various implementations, the real estate agent can identify one or a combination of a plurality of criteria that is used to identify a target region for the real estate agent.

The process 300 proceeds next to block 308, where e-flyers for the target region are queried. In various implementations, the e-flyer database server searches the e-flyer database for new or recently updated e-flyers that match the target region, such as those generated in FIG. 2.

The process 300 continues next at block 310, where the resulting e-flyers from the query are provided to the mobile computing device 122 of the real estate agent. In various implementations, the e-flyer distribution server 120 sends a notification or command to the mobile computing device 122 of the real estate agent, which causes the mobile computing device 122 to download or otherwise access the e-flyer results.

As discussed above, the e-flyer distribution server 120 selects specific e-flyers for the real estate agent based on predetermined criteria in real estate agent's stored profile. This automatic e-flyer selection allows for the e-flyer distribution server 120 to provide the real estate agent with new e-flyers as soon as they are released. In this way, real estate agents can receive a list of e-flyers for properties that are in their target region that may be of interest to their clients as soon as the property is listed. Similarly, the automatic e-flyer selection allows for the e-flyer distribution server 120 to provide the real estate agent updated e-flyers, which can provide real estate agents with real-time updates for when prices change or there is an update to the description of a property.

In some implementations, the real estate agent may also, or alternatively, perform a query for previously released e-flyers for particular properties, which is discussed in blocks 312, 314, and 316. In at least one implementation, this type of query is optional and blocks 312, 314, and 316 may not be performed.

At block 312, the e-flyer distribution server 120 receives a query request from the mobile computing device 122 of a real estate agent. In various implementations, the request may identify a zip code, city, state, radius from the current geographical location of the mobile computing device 122, or other characteristics of desired properties (e.g., square footage, lot size, price, etc.).

The process 300 proceeds to block 314, where e-flyers associated with the query request are determined. In various implementations, the e-flyer database server searches the e-flyer database for new or recently updated e-flyers that match the target region, such as those generated in FIG. 2.

The process 300 continues at block 316, where the resulting e-flyers from the query are provided to the mobile computing device 122 of the real estate agent. In various implementations, block 316 performs actions similar to those discussed above in conjunction with block 310 to provide e-flyers to the real estate agent.

After block 316, the process 300 terminates, ends, or otherwise returns to a calling process to perform other actions.

FIG. 4 is a logical flow diagram that illustrates one implementation of a process by a mobile computing device 122 for presenting an electronic flyer as described herein. In one implementation, FIG. 4 illustrates the process of an application, e.g., e-flyer-presentation module 128 in FIG. 1, executing on a mobile computing device 122 that creates platform that enables real estate agents to view and share e-flyer marketing information for their property listings. Briefly, the application includes an interface that communicates with the e-flyer distribution server to utilize a database-driven backend infrastructure.

The process 400 begins at block 402, where an identifier for the real estate agent is received. This real estate agent may be considered to be the user of the mobile computing device 122 that is executing the process 400. In some implementations, the identifier is an email address, phone number, username and password, or other unique identifier.

The process 400 proceeds to block 404, where the real-estate-agent identifier is provided to the e-flyer distribution server 120. In some implementations, the mobile computing device 122 of the real estate agent sends a command or other instruction to the e-flyer distribution server 120 to cause to the e-flyer distribution server 120 to perform a query for e-flyers in the real estate agent's target region, as described herein.

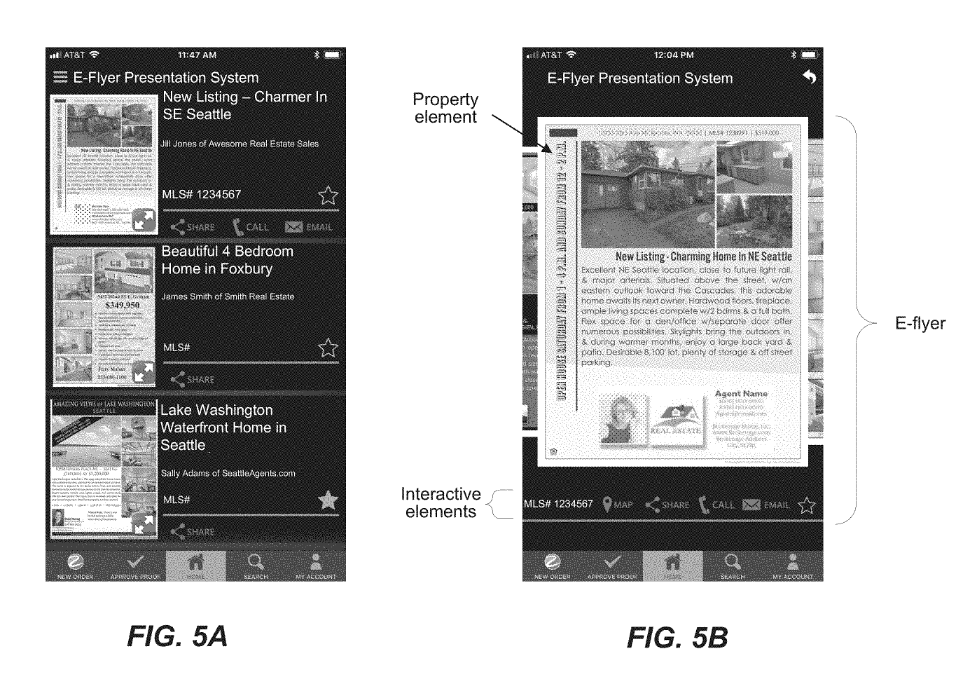

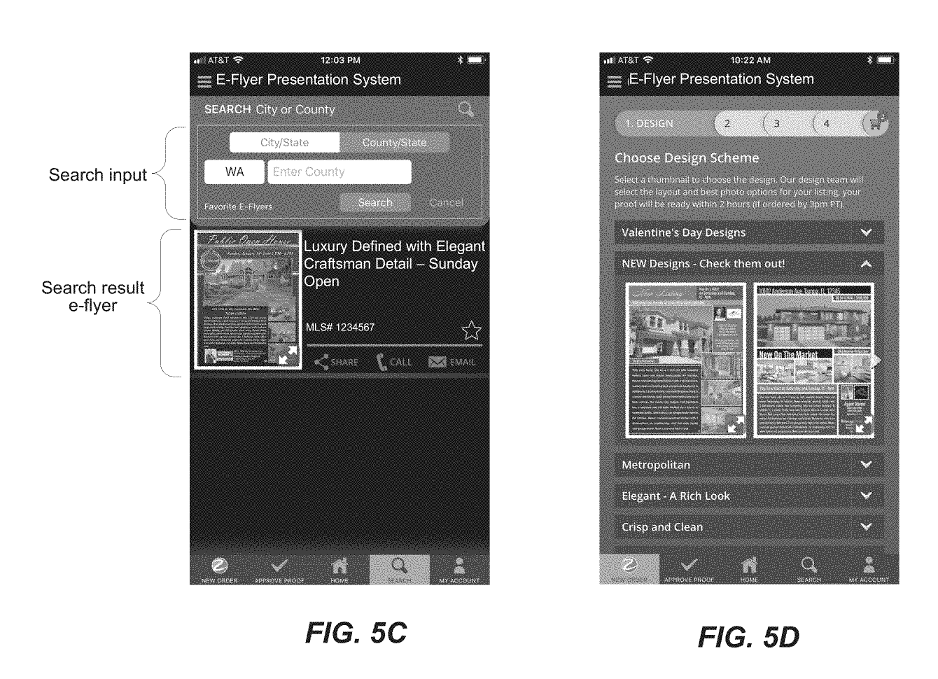

The process 400 continues at block 406, where one or more e-flyers are received from the e-flyer distribution server 120 and presented to the user. In various implementations, the e-flyers are presented as thumbnails or a scaled or miniaturized version of the e-flyers, such as illustrated in FIG. 5A. In at least one implementation, this presentation of e-flyers may be referred to as a feed, e-flyer board, wall, or other display format. In this way, the real estate agent can quickly scroll through multiple e-flyers without having to individually access each e-flyer.

In some implementations, a few listing details may also be presented along with the scaled e-flyers, such as the location, the name of the seller real estate agent, or other catchy descriptions selected by the seller real estate agent. In at least one implementation, the scaled version only includes the property element of the e-flyers. In another implementation, the scaled version includes the property element and one or more of the interactive elements. In this way, the real estate agent can quickly contact or forward the e-flyer without having to access a larger version of the e-flyer.

In some implementations, the real estate agent can click on the scaled version of an e-flyer to select that e-flyer to view a larger version, view additional details, or get access to the interactive elements of the e-flyer, Such as shown in FIG. 5B

The process 400 proceeds next to decision block 408, where a determination is made whether the real estate agent has input a query for other e-flyers. In various implementations, a search query interface may be provided to the real estate agent, where the real estate agent provides particular search criteria (e.g., zip code, city, state, radius from current geographical location, or other listing details), such as illustrated in FIG. 5C. If an additional query is received, the process 400 flows to block 410; otherwise, the process 400 flows to decision block 414.

At block 410, the e-flyer query is provided to the e-flyer distribution server 120. In some implementations, the mobile computing device 122 of the real estate agent sends a command or other instruction, along with the search criteria, to the e-flyer distribution server 120 to cause to the e-flyer distribution server 120 to perform a query for e-flyers based on the search criteria, as described herein.

The process 400 continues at block 412, where one or more e-flyers are received from the e-flyer distribution server 120 and presented to the user. In various implementations, the e-flyers are presented to the real estate agent in a manner similar to what is described above in conjunction with block 406.

If, at decision block 408 no additional search criteria is received, or after presentation of the e-flyers at block 412, the process 400 proceeds to decision block 414. At decision block 414, a determination is made whether an interactive input is received from the real estate agent for a given e-flyer. As discussed above, each e-flyer may include one or more interactive elements that enable the real estate agent to interact with the e-flyer. If a share e-flyer interaction is received, the process 400 flows to block 416. If a contact seller interaction is received, the process 400 flows to block 418. If a map property request is received, process 400 flows to block 420. In various implementations a real estate agent may perform one or a combination of these or other interactions.

At block 416, a sharing module is activated. In various implementations, a copy of the e-flyer may be posted to a social media page of the real estate agent, the e-flyer may be sent to another real estate agent or the real estate agent's client (e.g., a potential buyer) via text message, or the e-flyer may be sent to another real estate agent via email. In some implementations, only a portion of the e-flyer may be shared, such as the property element of the e-flyer. In other implementations, one or more of the interactive elements of the e-flyer may also be shared.

At block 418, a communication module is activated. In various implementations, this activation includes accessing the telephone or text message module or application of the mobile computing device 122.

At block 420, a map showing the property associated with the e-flyer is activated. In some implementations, this activation includes opening or accessing a map application on the mobile computing device 122 and linking an address or coordinates of the property from the e-flyer to the map application.

The above illustrated types of interactions are for illustrative purposes and other types of interactions may also be received. For example, the real estate agent may interact with an icon that includes a link to a website of the seller real estate agent. This type of interaction may activate a web browser on the mobile computing device 122 and navigate to the appropriate website. Other interactions with the e-flyer by the real estate agent are also possible.

The process 400 may loop to block 404 or 406 to obtain additional e-flyers in the real estate agent's target region; or the process 400 may loop to block 408 to receive addition e-flyer queries; or process 400 may loop to block 414 to receive additional interactive input; or the process 400 may terminate, end, or otherwise returns to a calling process to perform other actions.

FIGS. 5A-5D are screenshots of a mobile computing device 122 that is displaying real-time database-driven real estate electronic flyers. FIG. 5A illustrates a plurality of scaled e-flyers (or the property element from the associated e-flyers). FIG. 5B illustrates a selected e-flyer with the property element being larger and interactive elements being displayed near the bottom of the display screen. FIG. 5C illustrates an example search query interface and the results. FIG. 5D illustrates an alternative interface in which a real estate agent can input listing details that are provided to the e-flyer distribution server 120 so that the e-flyer distribution server 120 can generate a corresponding e-flyer, such as described in conjunction with FIG. 2. In other implementations, this interface may be used to review and accept a proof of an e-flyer or to make corresponding edits or changes. If a real estate agent provides such edits, the mobile computing device 122 sends commands or instructions, along with the edits, to the e-flyer distribution server 120 to cause the e-flyer distribution server 120 to modify the corresponding e-flyer and to redistribute the modified e-flyer based on the database of real-estate-agent profiles.

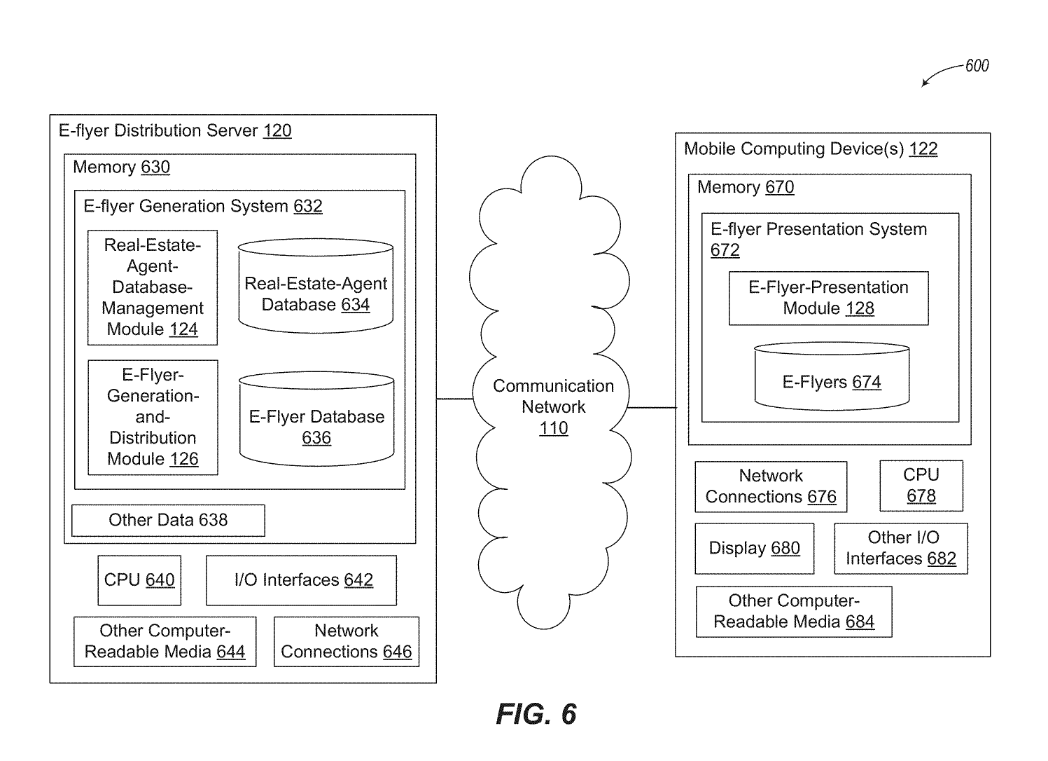

FIG. 6 is a system diagram of computing systems for implementation of the process and method of the present disclosure. System 600 includes e-flyer distribution server 120 and one or more mobile computing devices 122, similar to system 100 illustrated in FIG. 1.

The e-flyer distribution server 120 provides e-flyers to mobile computing device(s) 122. As discussed above, the e-flyer distribution server 120 generates e-flyers and utilizes a real estate agent database to provide real-time distribution of e-flyers to real estate agents. One or more special-purpose computing systems may be used to implement the e-flyer distribution server 120. Accordingly, various implementations described herein may be implemented in software, hardware, firmware, or in some combination thereof. The e-flyer distribution server 120 may include a memory 630, one or more central processing units (CPUs) 640, I/O interfaces 642, other computer-readable media 644, and network connections 646.

The memory 630 may include one or more various types of non-volatile and/or volatile storage technologies. Examples of the memory 630 may include, but are not limited to, flash memory, hard disk drives, optical drives, solid-state drives, various types of random access memory (RAM), various types of read-only memory (ROM), other computer-readable storage media (also referred to as processor-readable storage media), or the like, or any combination thereof. The memory 630 may be utilized to store information, including computer-readable instructions that are utilized by CPU 640 to perform actions described herein.

The memory 630 may have stored thereon an e-flyer generation system 632, which includes real-estate-agent-database-management module 124 and an e-flyer-generation-and-distribution module 126. The real-estate-agent-database-management module 124 may employ implementations described herein to generate and manage a plurality of real-estate-agent profiles in a real-estate-agent database 634. The e-flyer-generation-and-distribution module 126 may employ implementations described herein to generate e-flyers and distribute them to real estate agents via their corresponding mobile computing devices 122. The e-flyer-generation-and-distribution module 126 communicates with the real-estate-agent-database-management module 124 to determine which real estate agents to distribute the e-flyers to and their corresponding information for sending the e-flyer to their mobile computing device 1222.

Although the real-estate-agent-database-management module 124 and the e-flyer-generation-and-distribution module 126 are shown as separate modules, implementations are not so limited. Rather, a single module or a plurality of additional modules may be utilized to perform the functionality of the real-estate-agent-database-management module 124 and the e-flyer-generation-and-distribution module 126. Likewise, although the real-estate-agent-database-management module 124 and the e-flyer-generation-and-distribution module 126 are illustrated as being on a single e-flyer distribution server 120, implementations are not so limited, and a plurality of e-flyer distribution severs 120 may be utilized to implement the functionality of the real-estate-agent-database-management module 124 and the e-flyer-generation-and-distribution module 126.

The e-flyer generation system 632 also includes a real-estate-agent database 634 and an e-flyer database 636. The real-estate-agent database 634 stores profiles for each of a plurality of real estate agents. As discussed above, each profile may include identifying information for the corresponding real estate agent (including information identifying the mobile computing device 122 or the e-flyer-presentation module 128 of the real estate agent), one or a plurality of different zip codes or regions in which that real estate agent operates or is licensed to operate, a price range that the real estate agent is comfortable working in, the type or size of properties (e.g., lot size or house square footage) that the real estate agent's clients typically look for, specialized memberships that the real estate agent may have, or other types of information that can be used to classify or characterize the real estate agent so that they receive e-flyers that are relative to them and their clients. For example, the real estate agent's profile can also include other types of delivery information, such as time of date, e-flyer specific information, etc. The e-flyer database 636 stores a plurality of previously generated e-flyers.

In some implementations, the e-flyer database 636 also stores one or more e-flyers that are in the process of being generated, proofed, or reviewed. Additionally, the e-flyer database 636 may store one or more template e-flyers that can be utilized by real estate agents or designers to generate an e-flyer.

The memory 630 may also store other data 638, which may include images, icon, logos, or graphics for use in generating an e-flyer; login credential information for real-estate agents, or other data.

There are network connections 646 that are configured to communicate with other computing devices, such as the mobile computing device 122 via communication network 110. Other I/O interfaces 642 may include a keyboard, audio interfaces, video interfaces, or the like. Other computer-readable media 644 may include other types of stationary or removable computer-readable media, such as removable flash drives, external hard drives, or the like.

The mobile computing devices 122 receive e-flyers from the e-flyer distribution server 120 and present them to a user of the mobile computing device 122, i.e., a corresponding real estate agent. In various implementations, a real estate agent can utilize their mobile computing device 122 to create, modify, edit, or update a previously submitting or generated e-flyer stored on the e-flyer distribution server 120. One or more special-purpose computing systems may be used to implement a mobile computing device 122. Accordingly, various implementations described herein may be implemented in software, hardware, firmware, or in some combination thereof. The mobile computing devices 122 may include a memory 670, a plurality of network connections 676, one or more central processing units (CPUs) 678, a display 680, other I/O interfaces 682, and other computer-readable media 684.

The memory 670 may include one or more various types of non-volatile and/or volatile storage technologies, similar to what is described above for memory 630. The memory 670 may be utilized to store information, including computer-readable instructions that are utilized by CPU 678 to perform actions described herein.

The memory 670 may have stored thereon an e-flyer presentation system 672, which includes the e-flyer-presentation module 128 and the e-flyers 674. The e-flyer-presentation module 128 receives the e-flyers from the e-flyer-generation-and-distribution module 126 of the e-flyer distribution server 120 and presents them to a corresponding user real estate agent via the display 680. In some implementations, the e-flyer-presentation module 128 presents a graphical user interface in which the real estate agent can interact, such as by selecting or scrolling through multiple e-flyers, clicking on an interactive object in the e-flyer to correspond to a seller real estate agent associated with the e-flyer, save the e-flyer in the e-flyers 674, forward an e-flyer to another real estate agent, etc.

A display 680 may be a display device, such as a liquid crystal display or organic light-emitting diode touch screen or other type of display screen, or it may be a display interface that is configured to communication with a remote display device, such as a television, monitor, projector, or other display device.

Other I/O interfaces 682 may include a keyboard, audio interfaces, other video interfaces, or the like. The network connections 676 are configured to communicate with other computing devices, such as the e-flyer distribution server 120 or other mobile computing device 122, via the communication network 110. Other computer-readable media 684 may include other types of stationary or removable computer-readable media, such as removable flash drives, external hard drives, or the like.

In at least one implementation, the communication network 110 is configured to couple various computing devices to transmit content/data from one or more devices to one or more other devices. For example, the communication network 110 may be the Internet, X.25 networks, or a series of smaller or private connected networks that carry the content. The communication network 110 may include one or more wired or wireless networks.

The various implementations described above can be combined to provide further implementations. Aspects of the implementations can be modified, if necessary, to employ further concepts described herein.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A system, comprising:
a real-estate-agent database that includes a plurality of real-estate-agent profiles that each indicate a target region;
an e-flyer distribution server comprising a first memory that stores first computer instructions and a first processor that performs first actions when executing the first computer instructions, the first actions comprising:
receiving listing details of a property from a seller real estate agent;
generating an e-flyer based on the listing details, wherein the e-flyer includes a property element and at least one interactive element;
presenting the e-flyer to the seller real estate agent for acceptance; and
in response to receiving acceptance of the e-flyer and receiving a request from a target real estate agent, accessing the real-estate-agent database to select the e-flyer for distribution to the target real estate agent; and
a mobile computing device comprising a second memory that stores second computer instructions and a second processor that performs second actions when executing the second computer instructions, the second actions comprising:
providing the request from the target real estate agent to the e-flyer distribution server;
receiving the e-flyer;
presenting the property element of the e-flyer to the target real estate agent;
presenting the at least one interactive element of the e-flyer to the target real estate agent; and
in response to receiving an input to one of the at least one interactive element, performing additional actions associated with the e-flyer.

2. The system of claim 1, wherein the second processor of the mobile computing device performs the additional actions associated with the e-flyer by executing the second computer instructions to perform further second actions, the further second actions comprising:
posting a copy of the e-flyer to a social media page.

3. The system of claim 1, wherein the second processor of the mobile computing device performs the additional actions associated with the e-flyer by executing the second computer instructions to perform further second actions, the further second actions comprising:
sending a copy of the e-flyer to another computing device via text message or email.

4. The system of claim 1, wherein the second processor of the mobile computing device performs the additional actions associated with the e-flyer by executing the second computer instructions to perform further second actions, the further second actions comprising:
activating a telephone application of the mobile computing device to dial a phone number associated with the e-flyer.

5. The system of claim 1, wherein the second processor of the mobile computing device performs the additional actions associated with the e-flyer by executing the second computer instructions to perform further second actions, the further second actions comprising:
activating a map application of the mobile computing device to focus on a location of the property associated with the e-flyer.

6. The system of claim 1, wherein the property element includes at least one of a photo, a text, an icon, and a graphic depicting information regarding the property that is being presented in the e-flyer.

7. The system of claim 1, wherein the at least one interactive element includes at least one of a link to a website associated with the property, a link to a website associated with the seller real estate agent, information regarding the seller real estate agent, and mapping details regarding the property.

8. A method, comprising:
storing, on a real-estate-agent database, a plurality of real-estate-agent profiles that each indicate a target region for respective real estate agents;
receiving listing details and a selling target region for each property of a plurality of properties;
generating a plurality of e-flyers based on the listing details for each respective property, wherein each e-flyer includes a property element and at least one interactive element;
storing each respective e-flyer of the plurality of e-flyers in the real-estate-agent database based on the selling target region of the respective e-flyer;
receiving, from a computing device of a target real estate agent, a request for e-flyers;
accessing the real-estate-agent database to select one or more e-flyers based on the target region included in a real-estate-agent profile associated with the target real estate agent; and
distributing the one or more selected e-flyers to the computing device of the target real estate agent.

9. The method of claim 8, further comprising:
presenting the property element and the at least one interactive element of the one or more selected e-flyers to the target real estate agent; and
in response to receiving an input to one of the at least one interactive element of one of the one or more selected e-flyers, performing additional actions associated with the one e-flyer.

10. The method of claim 9, wherein performing the additional actions associated with the e-flyer comprises:
posting a copy of the e-flyer to a social media page.

11. The method of claim 9, wherein performing the additional actions associated with the e-flyer comprises:
sending a copy of the e-flyer to another computing device via text message or email.

12. The method of claim 9, wherein performing the additional actions associated with the e-flyer comprises:
activating a telephone application of a mobile computing device to dial a phone number associated with the e-flyer.

13. The method of claim 9, wherein performing the additional actions associated with the e-flyer comprises:
activating a map application of a mobile computing device to focus on a location of the property associated with the e-flyer.

14. The method of claim 8, further comprising:
receiving the listing details and the selling target region for a given property from a computing device of a seller real estate agent;
presenting, to the computing device of the seller real estate agent, an e-flyer for the given property for review and acceptance by the seller real estate agent; and
in response to receiving acceptance of the e-flyer for the given property from the computing device of the seller real estate agent, storing the e-flyer in the real-estate-agent database.

15. The method of claim 8, wherein, accessing the real-estate-agent database to select the one or more e-flyers includes:
identifying a target real-estate-agent profile of the plurality of real-estate-agent profiles that is associated with the target real estate agent;
determining the target region associated with the target real estate agent based on the target real-estate-agent profile;
querying the real-estate-agent database for e-flyers having a selling target region that matches the target region; and
selecting the one or more e-flyers that match the target region.

16. The method of claim 8, wherein, accessing the real-estate-agent database to select the one or more e-flyers includes:
receiving an identifier of the target real estate agent from the computing device of the target real estate agent;
identifying a target real-estate-agent profile of the plurality of real-estate-agent profiles based on the identifier; and
querying the real-estate-agent database for the one or more e-flyers that have a selling target region that matches the target region of the target real-estate-agent profile.

17. The method of claim 8, wherein, accessing the real-estate-agent database to select the one or more e-flyers includes:
receiving an e-flyer query request from the computing device of the target real estate agent for a given region;
querying the real-estate-agent database for e-flyers having a selling target region that matches the given region in the e-flyer query request; and
selecting the one or more e-flyers that match the given region.

18. A non-transitory computer-readable storage medium having stored thereon instructions that when executed by a processor, cause the processor to perform actions, the actions comprising:
receiving an identifier of an agent;
providing the identifier to a remote server to cause the remote server to query a database for a plurality of e-flyers that match a target region for the agent;
receiving the plurality of e-flyers from the remote server, wherein each of the plurality of e-flyers includes a property element and an interactive element;
presenting the property element and the interactive element of at least one of the plurality of e-flyers to the agent
receiving an interaction with the interactive element from the agent; and
performing an action in response to the interaction with the interactive element.

19. The non-transitory computer-readable storage medium of claim 18, wherein the property element includes at least one of a photo, a text, an icon, and a graphic depicting information regarding the property that is being presented in the e-flyer.

20. The non-transitory computer-readable storage medium of claim 18, wherein the at least one interactive element includes at least one of a link to a website associated with the property, a link to a website associated with the seller real estate agent, information regarding the seller real estate agent, and mapping details regarding the property.
